(19) United States
(12) Patent Application Publication
(10) Pub. No.: US 2010/0185442 A1
(43) Pub. Date: Jul. 22, 2010

(54) ADAPTIVE SOUND SOURCE VECTOR QUANTIZING DEVICE AND ADAPTIVE SOUND SOURCE VECTOR QUANTIZING METHOD

(75) Inventors: Kaoru Sato, Kanagawa (JP); Toshiyuki Morii, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/665,424

(22) PCT Filed: Jun. 20, 2008
(86) PCT No.: PCT/JP2008/001598

§ 371 Date: Dec. 18, 2009

(30) Foreign Application Priority Data
Jun. 21, 2007 (JP) 2007-163772

(51) Int. Cl. G10L 21/00

(52) U.S. Cl. 704/222; 704/E15.035

(57) ABSTRACT

It is an object to disclose an adaptive sound source vector quantizing device, etc. that can be configured to improve quantizing accuracy in adaptive sound source vector quantization to be carried out for every sub-frame. In this device, a pitch period designating unit (101) outputs a full search range as a pitch period searching range of a first sub-frame, a pitch period memory unit (107) stores a pitch period of each sub-frame, and a pitch period comparing unit (108) judges if a pitch period of the first sub-frame in the present frame exists in a predetermined range of a pitch period of a second sub-frame in the past frame and outputs “1” or “2” as a judged result, wherein the pitch period designating unit (101); outputs the predetermined range as the pitch period searching range of the second sub-frame in the present frame in the case where the output of the pitch period comparing unit (108) is “1” while the pitch period designating unit (101) outputs the full search range as the pitch period searching range of the second sub-frame in the present frame in the case where the output of the pitch period comparing unit (108) is “2”.

### TECHNICAL FIELD

The present invention relates to an adaptive excitation vector quantization apparatus and adaptive excitation vector quantization method for performing adaptive excitation vector quantization in CELP speech coding. In particular, the present invention relates to an adaptive excitation vector quantization apparatus and adaptive excitation vector quantization method for performing adaptive excitation vector quantization used for a speech coding/decoding apparatus for speech signal transmission in fields of, particularly, a packet communication system represented by Internet communication and a mobile communication system.

### BACKGROUND ART

In the fields of digital wireless communication, packet communication represented by Internet communication, speech storage and so on, a speech signal coding/decoding technology is essential for efficient use of channel capacity and storage media for radio waves. Particularly, CELP speech coding/decoding technology has become the mainstream technology (e.g. see Non-Patent Document 1).

A CELP speech coding apparatus encodes input speech based on speech models stored in advance. To be more specific, a CELP speech coding apparatus separates a digitized speech signal into frames of regular time intervals around 10 to 20 ms, acquires the linear prediction coefficients (“LPCs”) and linear prediction residual vector by performing a linear prediction analysis of the speech signal in each frame, and encodes the linear prediction coefficients and linear prediction residual vector separately. A CELP speech coding/decoding apparatus encodes/decodes a linear prediction residual vector using an adaptive excitation codebook storing excitation vector signals generated in the past and a fixed codebook storing a specific number of vectors of fixed shapes (i.e. fixed code vectors). Of these codebooks, the adaptive excitation codebook is used to represent the periodic components of the linear prediction residual vector, whereas the fixed codebook is used to represent the non-periodic components of the linear prediction residual vector, which cannot be represented by the adaptive excitation codebook.

The processing of encoding/decoding a linear prediction residual vector is generally performed in units of subframe dividing a frame into shorter time units (around 5 to 10 ms). According to ITU-T Recommendation G.729 disclosed in Non-Patent Document 2, a frame is divided into two subframes and the pitch period is searched for in each of the two subframes using the adaptive excitation codebook, to perform adaptive excitation vector quantization. To be more specific, there is a method called “delta lag,” whereby the pitch period of the first subframe is determined in a fixed range and the pitch period of the second subframe is determined in a close range to the pitch period determined in the first subframe. An adaptive excitation vector quantization method that operates in subframe units such as above can reduce the amount of calculations compared to an adaptive excitation vector quantization method that operates in frame units.

Non-Patent Document 1: M. R. Schroeder, B. S. Atal, “IEEE proc. ICASSP,” 1985, “Code Excited Linear Prediction: High Quality Speech at Low Bit Rate,” p. 937-940

### Non-Patent Document 2: “ITU-T Recommendation G.729,” ITU-T, 1996/3, pp. 17-19

### DISCLOSURE OF INVENTION

### Problems to be Solved by the Invention

However, with the above method of adaptive excitation vector quantization called a “delta lag,” whereby the pitch period of the second subframe is determined in a close range to the pitch period of the first subframe, although the continuity of the pitch period between the first subframe and the second subframe is taken into account, the continuity of the pitch period between the second subframe in the previous frame and the first subframe in the current frame is not taken into account. Further, if the pitch period varies significantly between the first subframe and the second subframe in the current frame and the pitch period of the second subframe cannot be represented accurately by the delta lag of the pitch period of the first subframe, there is a problem that the accuracy of adaptive excitation vector quantization degrades.

It is therefore an object of the present invention to provide an adaptive excitation vector quantization apparatus and adaptive excitation vector quantization method whereby, in a CELP speech coding apparatus that performs linear prediction coding on a per subframe basis, it is possible to take into account both the continuity of the pitch period between the second subframe in the previous frame and the first subframe in the current frame, and the continuity of the pitch period between the first subframe and the second subframe in the current frame, and, even if the pitch period varies significantly between the first subframe and the second subframe in the current frame, it is possible to improve the accuracy of adaptive excitation vector quantization.

### Means for Solving the Problem

The adaptive excitation vector quantization apparatus of the present invention that performs adaptive excitation vector quantization, using a linear prediction residual vector and a linear prediction coefficient per subframe acquired by dividing a frame into a plurality of subframes and performing a linear prediction analysis, employs a configuration having: a search section that searches for a pitch period of a first subframe in a current frame in a predetermined full search range, using a linear prediction residual vector and a linear prediction coefficient of the first subframe in the current frame; a pitch period storage section that stores pitch periods of subframes; a deciding section that decides whether or not the pitch period of the first subframe in the current frame exists in a predetermined range including a pitch period of a second subframe in a previous frame; a difference calculating section that, when the pitch period of the first subframe in the current frame exists in the predetermined range, calculates a difference between the pitch period of the first subframe in the current frame and the pitch period of the second subframe in the previous frame; and an encoding section that encodes the difference and a pitch period of a second subframe in the current frame.

The adaptive excitation vector quantization method of the present invention that performs adaptive excitation vector quantization, using a linear prediction residual vector and a linear prediction coefficient per subframe acquired by dividing a frame into a plurality of subframes and performing a linear prediction analysis, includes the steps of: searching for a pitch period of a first subframe of a current frame in a predetermined full search range, using a linear prediction residual vector and a linear prediction coefficient of the first subframe in the current frame; storing pitch periods of subframes; deciding whether or not the pitch period of the first subframe in the current frame exists in a predetermined range including a pitch period of a second subframe in a previous frame; when the pitch period of the first subframe in the current frame exists in the predetermined range, calculating a difference between the pitch period of the first subframe in the current frame and the pitch period of the second subframe in the previous frame; and encoding the difference and a pitch period of a second subframe in the current frame.

### ADVANTAGEOUS EFFECT OF THE INVENTION

According to the present invention, with a CELP speech coding apparatus that performs linear prediction coding on a per subframe basis, it is possible to take into account both the continuity of the pitch period between the second subframe in the previous frame and the first subframe in the current frame, and the continuity of the pitch period between the first subframe and the second subframe in the current frame, and, even if the pitch period varies significantly between the first subframe and the second subframe in the current frame, it is possible to improve the accuracy of adaptive excitation vector quantization.

### BRIEF DESCRIPTION OF DRAWINGS

FIG. 1 is a block diagram showing the main components of an adaptive excitation vector quantization apparatus according to an embodiment of the present invention;

FIG. 2 illustrates an excitation provided in an adaptive excitation codebook according to an embodiment of the present invention; and

FIG. 3 is a block diagram showing the main components of an adaptive excitation vector dequantization apparatus according to an embodiment of the present invention.

### BEST MODE FOR CARRYING OUT THE INVENTION

An example case will be described below with an embodiment of the present invention, where a CELP speech coding apparatus including an adaptive excitation vector quantization apparatus divides each frame forming a 16 kHz speech signal into two subframes and performs a linear prediction analysis on a per subframe basis, to determine the linear prediction coefficient and linear prediction residual vector of each subframe. Here, assume that the frame length is expressed as “n” and the subframe length is expressed as “m.”

An embodiment of the present invention will be explained below in detail with reference to the accompanying drawings.

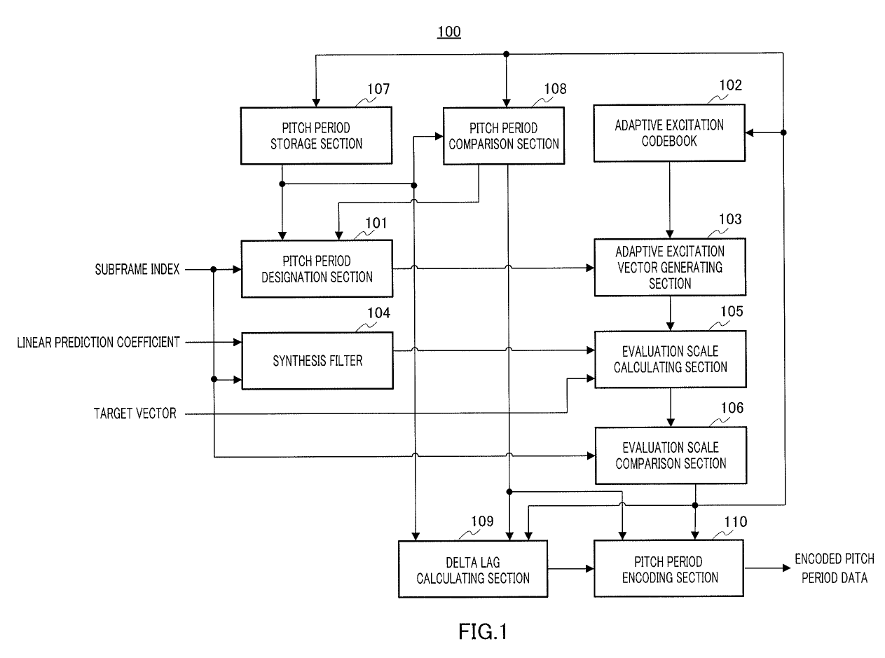

FIG. 1 is a block diagram showing the main components of adaptive excitation vector quantization apparatus 100 according to an embodiment of the present invention.

In FIG. 1, adaptive excitation vector quantization apparatus 100 is provided with pitch period designation section 101, adaptive excitation codebook 102, adaptive excitation vector generating section 103, synthesis filter 104, evaluation scale calculating section 105, evaluation scale comparison section 106, pitch period storage section 107, pitch period comparison section 108, delta lag calculating section 109 and pitch period encoding section 110, and adaptive excitation vector quantization apparatus 100 receives as input a subframe index, linear prediction coefficient and target vector per subframe. Of these, the subframe index represents the order of each subframe acquired by a CELP speech coding apparatus containing adaptive excitation vector quantization apparatus 100 according to the present embodiment, in a frame, and the linear prediction coefficient and target vector represent the linear prediction coefficient and linear prediction residual (excitation signal) vector of each subframe, determined by performing a linear prediction analysis on a per subframe basis in the CELP speech coding apparatus. Examples of parameters available as linear prediction coefficients include LPC parameters, LSF (Line Spectral Frequency) parameters that are frequency domain parameters convertible with LPC parameters in a one-to-one correspondence, and LSP (Line Spectral Pairs) parameters.

Pitch period designation section 101 sequentially designates pitch periods in a pitch period search range set in advance to adaptive excitation vector generating section 103, based on subframe indices received as input on a per subframe basis, the pitch period of the first subframe received as input from pitch period storage section 107 and a comparison result received as input from pitch period comparison section 108 (i.e. a decision result as to whether or not the first subframe in the current frame can be represented as the delta lag of the second subframe in the previous frame).

Adaptive excitation codebook 102 has a built-in buffer for storing excitations, and updates the excitations using a pitch period fed back from evaluation scale comparison section 106 every time a pitch period search in subframe units is finished.

Adaptive excitation vector generating section 103 clips an adaptive excitation vector having a pitch period candidate designated by pitch period designation section 101, by a subframe length m, from adaptive excitation codebook 102, and outputs the adaptive excitation vector to evaluation scale calculating section 105.

Synthesis filter 104 forms a synthesis filter using linear prediction coefficients that are received as input on a per subframe basis, generates an impulse response matrix of the synthesis filter based on the subframe indices received as input on a per subframe basis and outputs the impulse response matrix to evaluation scale calculating section 105.

Evaluation scale calculating section 105 calculates the evaluation scale for pitch period search using the adaptive excitation vector received as input from adaptive excitation vector generation section 103, the impulse response matrix received as input from synthesis filter 104 and the target vectors received as input on a per frame basis, and outputs the pitch period search evaluation scale to evaluation scale comparison section 106.

Based on the subframe indices received as input on a per frame basis, in each subframe, evaluation scale comparison section 106 determines the pitch period candidate of the time the maximum evaluation scale is received as input from evaluation scale calculation section 105, as the pitch period of that subframe, outputs the pitch period to adaptive excitation codebook 102, pitch period storage section 107, pitch period comparison section 108, delta lag calculating section 109 and pitch period encoding section 110.

Pitch period storage section 107 stores the pitch period of the first subframe received as input from evaluation scale comparison section 106 and outputs the stored pitch period of the previous subframe to pitch period designation section 101, pitch period comparison section 108 and delta lag calculating section 109.

Pitch period comparison section 108 compares the pitch period of the second subframe in the previous frame stored in pitch period storage section 107 and the pitch period of the first subframe in the current frame received as input from evaluation scale comparison section 106, decides whether or not the first subframe in the current frame can be represented as the delta lag of the second subframe in the previous frame, and outputs the number of the subframe whose pitch period is represented by a delta lag, as a comparison result, to pitch period designation section 101, delta lag calculating section 109 and pitch period encoding section 110. That is, if pitch period comparison section 108 decides that the first subframe in the current frame can be represented as the delta lag of the second subframe in the previous frame, pitch period comparison section 108 outputs “1” as the number of the subframe whose pitch period is represented by a delta lag. By contrast, if pitch period comparison section 108 decides that the first subframe in the current frame can be represented as the delta lag of the second subframe in the previous frame, pitch period comparison section 108 outputs “2” as the number of the subframe whose pitch period is represented by a delta lag.

Based on the comparison result received as input from pitch period comparison section 108, that is, based the decision result as to whether or not the first subframe in the current frame can be represented as the delta lag of the second subframe in the previous frame, delta lag calculating section 109 calculates, as a delta lag, the difference between the pitch period of the first subframe in the current frame received as input from evaluation scale comparison section 106 and the pitch period of the second subframe in the previous frame received as input from pitch period storage section 107, or the difference between the pitch period of the second subframe received as input from evaluation scale comparison section 106 and the pitch period of the first subframe in the current frame received as input from pitch period storage section 107, and outputs the delta lag to pitch period encoding section 110.

Pitch period encoding section 110 encodes the comparison result received as input from pitch period comparison section 108, the delta lag received as input from delta lag calculating section 109 and the index received as input from evaluation scale comparison section 106, and outputs the resulting encoded pitch period data.

The sections of adaptive excitation vector quantization apparatus 100 perform the following operations.

When a subframe index received as input on a per subframe basis indicates the first subframe, pitch period designation section 101 sequentially designates, to adaptive excitation vector generating section 103, pitch periods T_int's in a pitch period search range set in advance, for example, 256 pitch periods T_int's from “32” to “287” (T_int=32, 33, . . . , 287) corresponding to eight bits. Here, “32” to “287” represent the indices indicating pitch periods. Also, if a subframe index received as input on a per subframe basis indicates the second subframe, pitch period designation section 101 sequentially designates pitch periods T_int's based on the comparison result received as input from pitch period comparison section 108, to adaptive excitation vector generating section 103. To be more specific, based on the comparison result received as input from pitch period comparison section 108, if the number of the subframe whose pitch period is represented by a delta lag is “1,” pitch period designation section 101 sequentially designates pitch periods T_int's (T_int=32, 33, . . . , 287) to adaptive excitation vector generating section 103, as a pitch period search range in the second subframe. On the other hand, if the number of the subframe whose pitch period is represented by a delta lag is “2,” pitch period designation section 101 sequentially designates pitch periods T_int's (T_int=T1′−7, T1′−6, . . . , T1′, . . . , T1′+8) to adaptive excitation vector generating section 103, as a pitch period search range in the second subframe. Here, T1′ represents the pitch period of the first subframe received as input from pitch period storage section 107.

Adaptive excitation codebook 102 has a built-in buffer for storing excitations, and updates the excitations using an adaptive excitation vector having a pitch period T′ fed back from evaluation scale comparison section 106 every time a pitch period search in subframe units is finished.

Adaptive excitation vector generating section 103 clips the subframe length m of the adaptive excitation vector having the pitch period candidate T designated by pitch period designation section 101, from adaptive excitation codebook 102, and outputs the adaptive excitation vector as an adaptive excitation vector P(T) to evaluation scale calculating section 105. For example, when adaptive excitation codebook 102 is formed with vectors having a length of e as represented by exc(0), exc(1), . . . , exc(e−1), the adaptive excitation vector P(T) generated in adaptive excitation vector generating section 103 is represented by following equation 1.

$$\begin{matrix}( Equation 1 ) & \\ P ( T ) = P [ \begin{matrix}exc ( e - T ) \\ exc ( e - T + 1 ) \\ ⋮ \\ exc ( e\_T + m - 1 )\end{matrix} ] & [ 1 ]\end{matrix}$$

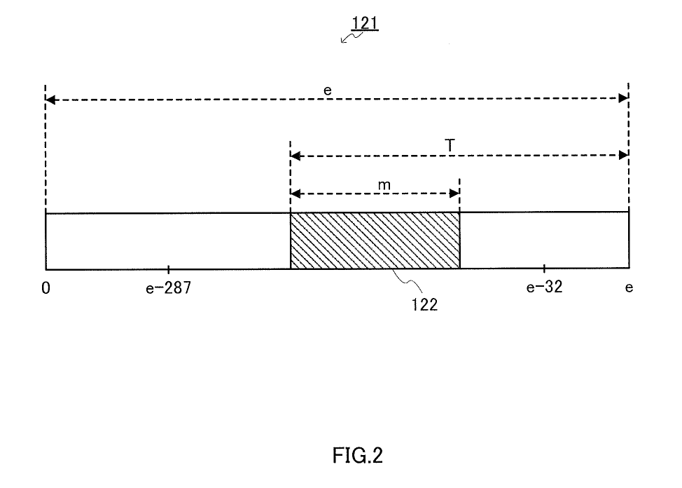

FIG. 2 illustrates an excitation provided in adaptive excitation codebook 102.

In FIG. 2, “e” represents the length of excitation 121, “m” represents the length of the adaptive excitation vector P(T) and “T” represents a pitch period candidate designated by pitch period designation section 101. As shown in FIG. 2, adaptive excitation vector generating section 103 sets a position at a distance T from the tail end (position of e) of excitation 121 (adaptive excitation codebook 102) as the starting point, clips portion 122 of the subframe length m from the starting point in the direction of the tail end e, and generates an adaptive excitation vector P(T). Here, when the value of T is less than m, adaptive excitation vector generating section 103 may repeat the clipped portion until the length thereof is the subframe length m. Adaptive excitation vector generating section 103 repeats the clipping processing represented by above equation 1 on all T′s within the search range designated by pitch period designation section 101.

Synthesis filter 104 forms a synthesis filter using the linear prediction coefficients received as input on a per subframe basis. When a subframe index received as input on a per subframe basis indicates the first subframe, synthesis filter 104 generates an impulse response matrix represented by following equation 2, and, when the subframe index indicates the second subframe, generates an impulse response matrix represented by following equation 3. Synthesis filter 104 then outputs the impulse response matrix to evaluation scale calculating section 105.

$$\begin{matrix}( Equation 2 ) & \\ H = [ \begin{matrix}h ( 0 ) & 0 & … & 0 \\ h ( 1 ) & h ( 0 ) & … & 0 \\ ⋮ & ⋮ & ⋱ & ⋮ \\ h ( m - 1 ) & h ( m - 2 ) & … & h ( 0 )\end{matrix} ] & [ 2 ] \\ ( Equation 3 ) & \\ H\_ahead = [ \begin{matrix}h\_a ( 0 ) & 0 & … & 0 \\ h\_a ( 1 ) & h\_a ( 0 ) & … & 0 \\ ⋮ & ⋮ & ⋱ & ⋮ \\ h\_a ( m - 1 ) & h\_a ( m - 2 ) & … & h\_a ( 0 )\end{matrix} ] & [ 3 ]\end{matrix}$$

As shown in equation 2 and equation 3, both the impulse response matrix H when the subframe index indicates the first subframe, and the impulse response matrix H_ahead when the subframe index indicates the second subframe, are acquired by the subframe length m.

When a subframe index received as input on a per subframe basis indicates the first subframe, evaluation scale calculating section 105 receives as input the target vector X represented by following equation 4, and also receives as input the impulse response matrix H from synthesis filter 104, calculates an evaluation scale Dist(T) for a pitch period search according to following equation 5, and outputs the evaluation scale Dist(T) to evaluation scale comparison section 106. On the other hand, when a subframe index received as input in adaptive excitation vector quantization apparatus 100 on a per subframe basis indicates the second subframe, evaluation scale calculating section 105 receives as input the target vector X_ahead represented by following equation 6, also receives as input the impulse response matrix H_ahead from synthesis filter 104, calculates an evaluation scale Dist(T) for a pitch period search according to following equation 7 and outputs the evaluation scale Dist(T) to evaluation scale comparison section 106.

$$\begin{matrix}( Equation 4 ) & \\ X = [ \begin{matrix}x ( 0 ) & x ( 1 ) & … & x ( m - 1 )\end{matrix} ] & [ 4 ] \\ ( Equation 5 ) & \\ Dist ( T ) = \frac{{( XHP ( T ) )}^{2}}{{\vert HP ( T ) \vert}^{2}} & [ 5 ] \\ ( Equation 6 ) & \\ X\_ahead = [ \begin{matrix}x ( m ) & x ( m + 1 ) & … & x ( n - 1 )\end{matrix} ] & [ 6 ] \\ ( Equation 7 ) & \\ Dist ( T ) = \frac{{( X\_aheadH \_aheadP ( T ) )}^{2}}{{\vert H\_aheadP ( T ) \vert}^{2}} & [ 7 ]\end{matrix}$$

As shown in equation 5 and equation 7, evaluation scale calculating section 105 calculates, as an evaluation scale, the square error between the target vector X or X_ahead and a regenerated vector acquired by convoluting the impulse response matrix H or H_ahead generated in synthesis filter 104 and the adaptive excitation vector P(T) generated in adaptive excitation vector generating section 103. Upon calculating the evaluation scale Dist(T), evaluation scale calculating section 105 generally uses the matrix H′ (=H×W) or H′_ahead (=H_ahead×W) acquired by multiplying the impulse response matrix H or H_ahead and the impulse response matrix W of a perceptual weighting filter included in the CELP speech coding apparatus, instead of the impulse response matrix H or H_ahead in above equation 5 or equation 7. Here, assume that no distinction is made between H or H_ahead and H′ or H′_ahead, and H or H_ahead will be described in the following explanation.

Based on the subframe indices received as input on a per subframe basis, in each subframe, evaluation scale comparison section 106 determines the pitch period candidate T of the time the maximum evaluation scale Dist(T) is received as input from evaluation scale calculating section 105, as the pitch period T′ of each subframe, and outputs the results to adaptive excitation codebook 102, pitch period storage section 107, pitch period comparison section 108, delta lag calculating section 109 and pitch period encoding section 110.

Pitch period storage section 107 is formed with a buffer for storing the pitch period of the first subframe and updates the built-in buffer using the pitch period T′ fed back from evaluation scale comparison section 106 every time a pitch period search in subframe units is finished.

Pitch period comparison section 108 compares the pitch period T2′_pre of the second subframe in the previous frame received as input from pitch period storage section 107 and the pitch period T1′ of the first subframe in the current frame received as input from evaluation scale comparison section 106, and decides whether or not the pitch period T1′ of the first subframe in the current frame can be represented by a delta lag of the pitch period T2′_pre of the second subframe in the previous frame. To be more specific, if T1′ is included in the range from T2′_pre−7 to T2′_pre+8 (T2′_pre−7, T2′_pre−6, . . . , T2′_pre, T2′_pre+1, . . . , T2′_pre+8), pitch period comparison section 108 can decide that T1′ can be represented as a delta lag of T2′_pre. If the pitch period T1′ of the first subframe in the current frame can be represented by a delta lag of the pitch period T2′_pre of the second subframe in the previous frame, it is possible to encode the pitch period of the first subframe in the current frame with four bits of information, and, instead, it is possible to perform a full search of the pitch period of the second subframe in the current frame with eight bits of information.

On the other hand, if the pitch period T1′ of the first subframe in the current frame cannot be represented by a delta lag of the pitch period T2′_pre of the second subframe in the previous frame, eight bits of information is required to encode the pitch period of the first subframe in the current frame, and a pitch period search is performed in the second subframe in the current frame by a “delta lag” with four bits of information. As a comparison result, pitch period comparison section 108 outputs the number of the subframe whose pitch period is represented by a delta lag, “1” or “2,” to pitch period designation section 101, delta lag calculating section 109 and pitch period encoding section 110.

If the comparison result received as input from pitch period comparison section 108 is “1,” delta lag calculating section 109 calculates, as a delta lag, the difference between the pitch period T1′ of the first subframe in the current frame received as input from evaluation scale comparison section 106 and the pitch period T2′_pre of the second subframe in the previous frame received as input from pitch period storage section 107, and outputs the delta lag to pitch period encoding section 110. For example, delta lag calculating section 109 outputs, to pitch period encoding section 110, one of 16 candidates “−7, −6, . . . , 0, . . . , 7, 8” indicating the difference between the pitch period T1′ of the first subframe in the current frame and the pitch period T2′_pre of the second subframe in the previous frame (i.e. T1′−T2′_pre).

By contrast, if the comparison result received as input from pitch period comparison section 108 is “2,” delta lag calculating section 109 calculates, as a delta lag, the difference between the pitch period T2′ of the second subframe in the current frame received as input from evaluation scale comparison section 106 and the pitch period T1′ of the first subframe in the current frame received as input from pitch period storage section 107, and outputs the delta lag to pitch period encoding section 110. For example, delta lag calculating section 109 outputs, to pitch period encoding section 110, one of 16 candidates “−7, −6, . . . , 0, . . . , 7, 8” indicating the difference between the pitch period T2′ of the second subframe in the current frame and the pitch period T1′ of the first subframe in the current frame (i.e. T2′−T1′).

If the comparison result received as input from pitch period comparison section 108 is “1,” pitch period encoding section 110 encodes the parameter indicating the pith period T′ of the first subframe in the current frame, that is, the delta lag received as input from delta lag calculating section 109, with four bits of information, and encodes the pitch period T2′ of the second subframe in the current frame received as input from evaluation scale comparison section 106, with eight bits of information. For example, pitch period encoding section 110 encodes, with four bits, one of 16 candidates “−7, −6, . . . , 0, . . . , 7, 8” indicating the difference between the pitch period T1′ of the first subframe in the current frame and the pitch period T2′_pre of the second subframe in the previous frame (i.e. T1′−T2′_pre), and encodes, with eight bits, the pitch period T2′ of the second subframe in the current frame indicated by one of 256 candidates “32, 33, . . . , 287.”

By contrast, if the comparison result received as input from pitch period comparison section 108 is “2,” pitch period encoding section 110 encodes the pitch period T1′ of the first subframe in the current frame received as input from evaluation scale comparison section 106, with eight bits of information, and encodes the parameter indicating pitch period T2′ of the second subframe in the current frame, that is, the delta lag received as input from delta lag calculating section 109, with four bits of information. For example, pitch period encoding section 110 encodes, with eight bits, the pitch period T1′ of the first subframe in the current frame indicated by one of 256 candidates “32, 33, . . . , 287,” and encodes, with four bits, one of 16 candidates “−7, −6, . . . , 0, . . . , 7, 8” indicating the difference between the pitch period T2′ of the second subframe in the current frame and the pitch period T1′ of the first subframe in the current frame (i.e. T2′−T1′).

Also, pitch period encoding section 110 encodes the comparison result received as input from pitch period comparison section 108, that is, the number of the subframe whose pitch period is represented by a delta lag, with one bit of information.

Pitch period encoding section 110 outputs the encoded pitch period or delta lag of each subframe and the encoded comparison result to the CELP speech coding apparatus as encoded pitch period data.

The configuration and operations of adaptive excitation vector quantization apparatus 100 according to the present embodiment have been explained.

The CELP speech coding apparatus including adaptive excitation vector quantization apparatus 100 transmits encoded speech information including encoded pitch period data generated in pitch period encoding section 110, to the CELP decoding apparatus including the adaptive excitation vector dequantization apparatus according to the present embodiment. The CELP decoding apparatus decodes the received, encoded speech information, acquires decoded pitch period data including the index or delta lag of the pitch period of each subframe and a comparison result, and outputs the decoded pitch period data to the adaptive excitation vector dequantization apparatus according to the present embodiment. The speech decoding processing by the CELP decoder is also performed in subframe units in the same way as the speech coding processing by the CELP speech coder, and the CELP decoder outputs the subframe index to the adaptive excitation vector dequantization apparatus according to the present embodiment.

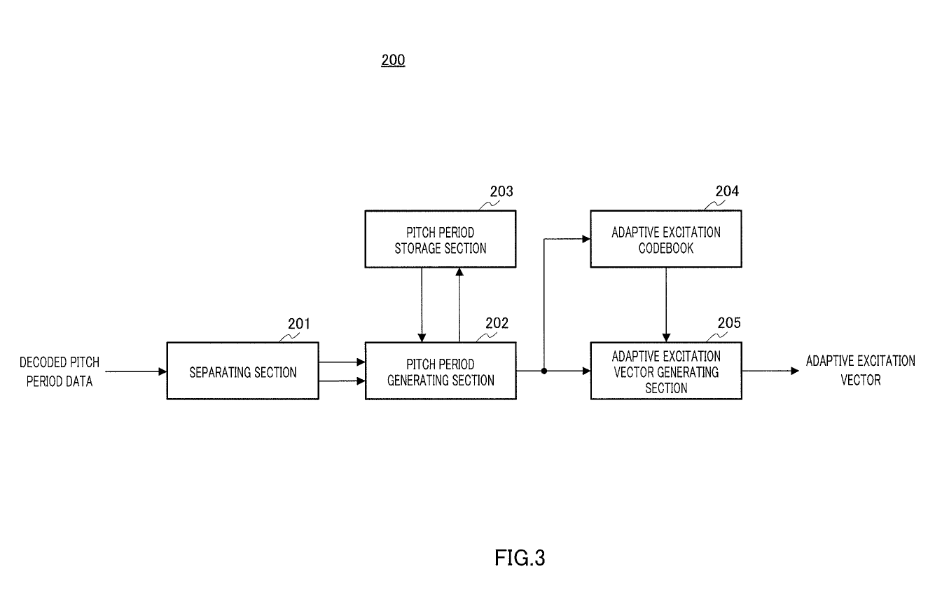

FIG. 3 is a block diagram showing the main components of adaptive excitation vector dequantization apparatus according to the present embodiment.

In FIG. 3, adaptive excitation vector dequantization apparatus 200 is provided with separating section 201, pitch period generating section 202, pitch period storage section 203, adaptive excitation codebook 204 and adaptive excitation vector generating section 205, and receives as input a subframe index and decoded pitch period data generated in the CELP speech decoding apparatus.

Separating section 201 separately separates the index or delta lag of the pitch period of each subframe and a comparison result from the decoded pitch period data received as input, and outputs the results to pitch period generating section 202.

Pitch period generating section 202 generates the pitch period T″ of each subframe based on the comparison result received as input from separating section 201, and outputs the results to pitch period storage section 203, adaptive excitation codebook 204 and adaptive excitation vector generating section 205. To be more specific, if the comparison result is “1,” pitch period generating section 202 adds the delta lag of the pitch period of the first subframe in the current frame received as input from separating section 201 and the index of the pitch period of the second subframe in the previous frame read from pitch period storage section 203, uses the pitch period indicated by the resulting index as the pitch period T1″ of the first subframe in the current frame, and directly uses the pitch period indicated by the index of the second subframe in the current frame received as input from separating section 201, as the pitch period T2″ of the second subframe in the current frame.

By contrast, if the comparison result is “2,” pitch period generating section 202 directly uses the pitch period indicated by the index of the first subframe in the current frame received as input from separating section 201, as the pitch period T1″ of the first subframe in the current frame, adds the index of the pitch period of the second subframe in the current frame received as input from separating section 201 and the index indicating the pitch period of the first subframe in the current frame read from pitch period storage section 203, and uses the pitch period indicated by the resulting index as the pitch period T2″ of the second subframe in the current frame.

Pitch period storage section 203 stores the pitch period T″ of each subframe received as input from pitch period generating section 202, and pitch period generating section 202 reads the pitch period T″ of the processing of the subsequent subframe.

Adaptive excitation codebook 204 has a built-in buffer for storing excitations similar to the excitations provided in adaptive excitation codebook 102 of adaptive excitation vector quantization apparatus 100, and updates excitations using an adaptive excitation vector having the pitch period T″ received as input from pitch period generating section 202 every time adaptive excitation decoding processing in subframe units is finished.

Adaptive excitation vector generating section 205 clips the subframe length m of the adaptive excitation vector P′(T″) having the pitch period T″ received as input from pitch period generating section 202, from adaptive excitation codebook 204, and outputs the adaptive excitation vector P′(T″) as an adaptive excitation vector for each subframe. The adaptive excitation vector P′(T″) generated in adaptive excitation vector generating section 205 is represented by following equation 8.

$$\begin{matrix}( Equation 8 ) & \\ {P}^{′} ( {T}^{″} ) = {P}^{′} [ \begin{matrix}exc ( e - {T}^{″} ) \\ exc ( e - {T}^{″} + 1 ) \\ ⋮ \\ exc ( {e\_T}^{″} + m - 1 )\end{matrix} ] & [ 8 ]\end{matrix}$$

Thus, according to the present embodiment, based on a comparison result between the pitch period of the first subframe in the current frame and the pitch period of the second subframe in the previous frame, by representing the pitch period of the first subframe in the current frame as the delta lag of the second subframe in the previous frame and encoding the pitch period, it is possible to take into account the time continuity between the pitch period of the second subframe in the previous frame and the pitch period of the first subframe in the current frame. Further, by changing the pitch period search in the second subframe to a full search, even if the pitch period varies significantly between the first subframe and the second subframe, it is possible to support a significant variation by the full search, so that it is possible to perform a pitch period search efficiently.

That is, based on a comparison result between the pitch period of the first subframe in the current frame and the pitch period of the second subframe in the previous frame, a subframe whose pitch period is represented by a delta lag is determined, so that it is possible to take into account both the time continuity between the pitch period of the second subframe in the previous frame and the pitch period of the first subframe in the current frame, and the time continuity between the pitch period of the first subframe in the current frame and the pitch period of the second subframe in the current frame, and, even if the pitch period varies significantly between the first subframe and the second subframe in the current frame, it is possible to improve the accuracy of adaptive excitation vector quantization.

Although an example case has been described above with the present embodiment where a linear prediction residual vector is received as input and where the pitch period of a linear prediction residual vector is searched for using an adaptive excitation codebook, the present invention is not limited to this, and it is equally possible to receive as input a speech signal itself and directly search for the pitch period of the speech signal itself.

Further, although an example case has been described above with the present embodiment where the range from “20” to “237” is used as pitch period candidates, the present invention is not limited to this, and other ranges may be used as pitch period candidates.

Also, although a case has been described above with the present embodiment as a premise where the CELP speech coding apparatus including adaptive excitation vector quantization apparatus 100 divides a frame into two subframes and performs a linear prediction analysis of these subframes individually, the present invention is not limited to this, and it is equally possible to premise that a CELP speech coding apparatus divides a frame into three subframes or more and perform a linear prediction analysis of these subframes individually. For example, when the present invention is applied to a case where a frame is divided into three subframes, it is possible to employ a configuration in which a pitch period search in the first subframe is fixed to a full search, and in which a full search method and a delta lag method are switched between the pitch period search in the second subframe and the pitch period search in the third subframe. With this configuration, a full search is always performed for pitch period search in the first subframe, so that, in the current frame, information about the pitch period of the previous frame is not necessary, and, even in the case where transmission error such as frame loss is caused, it is possible to prevent the influence of erroneous transmission.

The adaptive excitation vector quantization apparatus and adaptive excitation vector dequantization apparatus according to the present invention can be mounted on a communication terminal apparatus in a mobile communication system that performs speech transmission, and can therefore provide a communication terminal apparatus providing operations and effects similar to those described above.

Although a case has been described above with the above embodiments as an example where the present invention is implemented with hardware, the present invention can be implemented with software. For example, by describing the adaptive excitation vector quantization method according to the present invention in a programming language, storing this program in a memory and making the information processing section execute this program, it is possible to implement the same function as the adaptive excitation vector quantization apparatus according to the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-163772, filed on Jun. 21, 2007, including the specification, drawings and abstract, is incorporated herein by reference in its entirety.

### INDUSTRIAL APPLICABILITY

The adaptive excitation vector quantization apparatus and adaptive excitation vector quantization method according to the present embodiment are applicable to, for example, speech coding and speech decoding.

1. An adaptive excitation vector quantization apparatus that performs adaptive excitation vector quantization, using a linear prediction residual vector and a linear prediction coefficient per subframe acquired by dividing a frame into a plurality of subframes and performing a linear prediction analysis, the apparatus comprising:
a search section that searches for a pitch period of a first subframe in a current frame in a predetermined full search range, using a linear prediction residual vector and a linear prediction coefficient of the first subframe in the current frame;
a pitch period storage section that stores pitch periods of subframes;
a deciding section that decides whether or not the pitch period of the first subframe in the current frame exists in a predetermined range including a pitch period of a second subframe in a previous frame;
a difference calculating section that, when the pitch period of the first subframe in the current frame exists in the predetermined range, calculates a difference between the pitch period of the first subframe in the current frame and the pitch period of the second subframe in the previous frame; and
an encoding section that encodes the difference and a pitch period of a second subframe in the current frame.

2. The adaptive excitation vector quantization apparatus according to claim 1, wherein, if the pitch period of the first subframe in the current frame exists in the predetermined range, the search section searches for the pitch period of the second subframe in the current frame in the full search range, and, if the pitch period of the first subframe in the current frame does not exist in the predetermined range, the search section searches for the pitch period of the second subframe in the current frame in the predetermined range.

3. An adaptive excitation vector quantization method that performs adaptive excitation vector quantization, using a linear prediction residual vector and a linear prediction coefficient per subframe acquired by dividing a frame into a plurality of subframes and performing a linear prediction analysis, the method comprising the steps of:
searching for a pitch period of a first subframe of a current frame in a predetermined full search range, using a linear prediction residual vector and a linear prediction coefficient of the first subframe in the current frame;
storing pitch periods of subframes;
deciding whether or not the pitch period of the first subframe in the current frame exists in a predetermined range including a pitch period of a second subframe in a previous frame;
when the pitch period of the first subframe in the current frame exists in the predetermined range, calculating a difference between the pitch period of the first subframe in the current frame and the pitch period of the second subframe in the previous frame; and
encoding the difference and a pitch period of a second subframe in the current frame.
